(19) United States
(12) Patent Application Publication
(10) Pub. No.: US 2020/0134922 A1
(43) Pub. Date: Apr. 30, 2020

(54) MOVABLE BODY

(71) Applicant: TOYOTA JIDOSHA KABUSHIKI KAISHA, Toyota-shi (JP)

(72) Inventors: Takeshi KAMA, Nagakute-shi (JP); Yusuke HARA, Nagoya-shi (JP); Hiroshi HIRAIWA, Toyota-shi (JP); Takahiro SHIGA, Chiryu-shi (JP)

(73) Assignee: TOYOTA JIDOSHA KABUSHIKI KAISHA, Toyota-shi (JP)

(21) Appl. No.: 16/545,064

(22) Filed: Aug. 20, 2019

(30) Foreign Application Priority Data
Oct. 30, 2018 (JP) 2018-203814

(51) Int. Cl. G06T 19/00; G01S 19/42; G01S 19/39; G06F 3/0481

(52) U.S. Cl. CPC G06T 19/006; G01S 19/42; G06F 3/04815; G06T 19/003; G01S 19/393

(57) ABSTRACT

A movable body configured to travel with a rider on board includes a control device, and a display device. The control device is configured to acquire a current position of the movable body and acquire a current traveling direction of the movable body. The display device is installed such that the rider is able to see the display device. The control device is configured to execute control such that the display device displays a performance image corresponding to the current position and the current traveling direction.

### INCORPORATION BY REFERENCE

The disclosure of Japanese Patent Application No. 2018-203814 filed on Oct. 30, 2018 including the specification, drawings and abstract is incorporated herein by reference in its entirety.

### BACKGROUND

### 1. Technical Field

The disclosure relates to a movable body, such as a small vehicle.

### 2. Description of Related Art

One- or two-seater small vehicles are coming into widespread use in various situations. Especially in sightseeing spots and the like, small vehicles offer the following advantage: tourists can do sightseeing in a wider region within a shorter time when they use small vehicles than when they do sightseeing on foot. In recent years, tourists usually obtain sightseeing spot information via information terminals. For example, Japanese Unexamined Patent Application Publication No. 2005-276036 (JP 2005-276036 A) describes a technique of providing sightseeing spot information obtained from images captured at sightseeing spots to terminals carried by tourists, upon requests from the tourists.

### SUMMARY

With a system described in JP 2005-276036 A, a tourist can obtain sightseeing spot information. However, the sightseeing spot information lacks realism, and it is therefore not possible to give the tourist a realistic feeling of seeing the scenery that used to be spread out or a realistic feeling of seeing a building that used to exist.

The disclosure provides a movable body configured to enable a rider to obtain information about a location where the rider is and to enable the rider to have a virtual experience full of realism while the rider is traveling on the movable body.

An aspect of the disclosure relates to a movable body configured to travel with a rider on board. The movable body includes a control device and a display device. The control device is configured to acquire a current position of the movable body and acquire a current traveling direction of the movable body. The display device is installed such that the rider is able to see the display device. The control device is configured to execute control such that the display device displays a performance image corresponding to the current position and the current traveling direction.

In the movable body according to the aspect of the disclosure, the control device may be configured to execute control such that the display device displays an image of scenery seen from a point of view based on the current position and the current traveling direction, the scenery being scenery at a time point that differs from present time.

In the movable body according to the aspect of the disclosure, the control device may be configured to execute control such that the display device displays an image of virtual reality superimposed on actual scenery.

In the movable body according to the aspect of the disclosure, the control device may be further configured to measure a travel distance of the movable body and a traveling direction of the movable body. The control device may be configured to execute control such that the display device displays an image of an inside of a building that the rider is not able to actually enter, based on the measured travel distance of the movable body and the measured traveling direction of the movable body.

In the movable body according to the aspect of the disclosure, the control device may be configured to execute control such that a video image of the inside of the building is changed based on the measured travel distance of the movable body and the measured traveling direction of the movable body.

The movable body according to the aspect of the disclosure may further include a sound output device. The control device may be configured to control the sound output device such that the sound output device outputs sound matching an image displayed on the display device.

The movable body according to the aspect of the disclosure may further include a camera configured to capture a video image of scenery coming into the rider's field of vision. The control device may be configured to execute control such that the performance image is superimposed on the video image captured by the camera.

According to the aspect of the disclosure, it is possible to provide a movable body configured to enable a rider to obtain information about a location where the rider is and to enable the rider to have a virtual experience full of realism while the rider is traveling on the movable body.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a view illustrating the overall configuration of a movable body according to a first embodiment;

FIG. 2 is an enlarged view of an upper portion of an operating handle of the movable body according to the first embodiment;

FIG. 3 is a block diagram illustrating the system configuration of the movable body according to the first embodiment;

FIG. 4 is a block diagram illustrating functional modules to be implemented by a control device of the movable body according to the first embodiment;

FIG. 5 is a flowchart illustrating operations of the movable body according to the first embodiment; and

FIG. 6 is a view illustrating the overall configuration of a movable body according to a second embodiment.

### DETAILED DESCRIPTION OF EMBODIMENTS

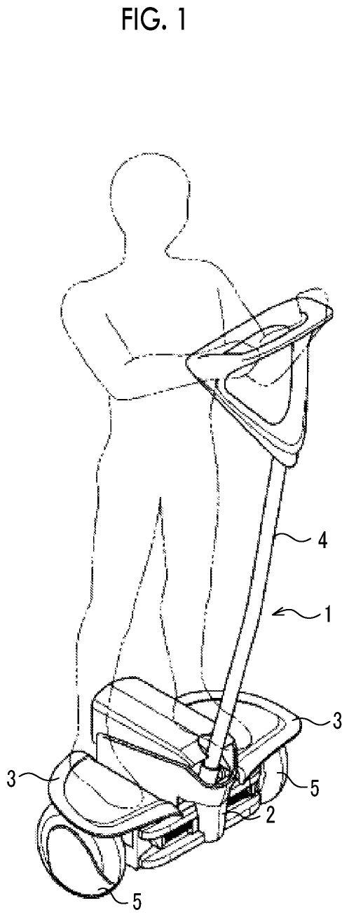

Hereinafter, example embodiments will be described in detail with reference to the accompanying drawings. FIG. 1 is a view illustrating the overall configuration of a movable body 1 according to a first embodiment. As illustrated in FIG. 1, the movable body 1 includes a vehicle body 2, a pair of right and left step parts 3, an operating handle 4, and a pair of right and left drive wheels 5. The step parts 3 are attached to the vehicle body 2 and configured such that a rider steps on the step parts 3. The operating handle 4 is tiltably attached to the vehicle body 2 and configured to be gripped by the rider. The drive wheels 5 are rotatably attached to the vehicle body 2.

The movable body 1 is, for example, a coaxial two-wheeled vehicle that includes the drive wheels 5 coaxially disposed, and that is configured to travel in an inverted pendulum state. The movable body 1 is configured to travel forward or backward when the rider shifts the rider's center of gravity (shifts the rider's weight) forward or backward to tilt the step parts 3 forward or backward. Further, the movable body 1 is configured to turn to the right or turn to the left when the rider shifts the rider's center of gravity rightward or leftward to tilt the step parts 3 rightward or leftward. The movable body 1 is not limited to the coaxial two-wheeled vehicle described above, and any movable body configured to travel in an inverted pendulum state may be used as the movable body 1.

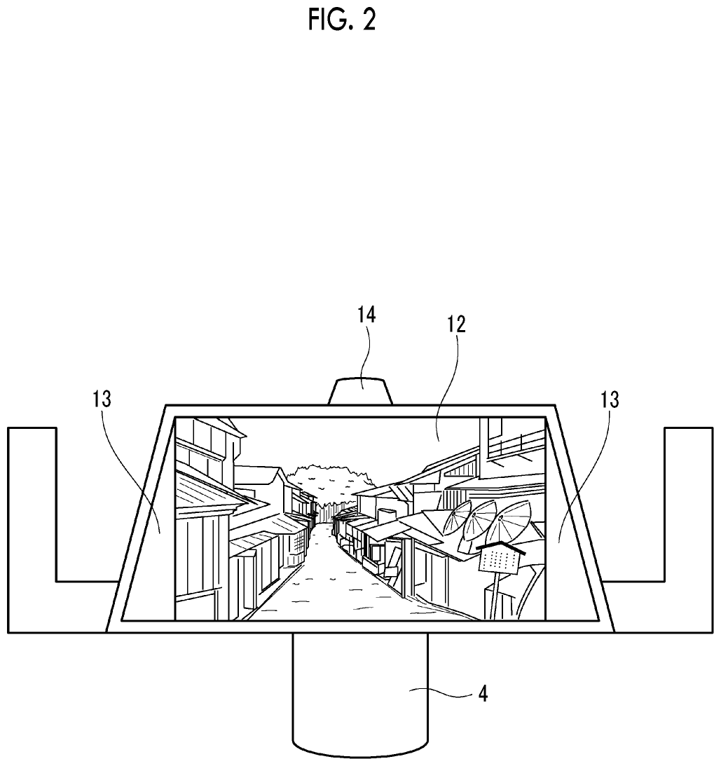

FIG. 2 is an enlarged view of an upper portion of the operating handle 4 of the movable body 1. As illustrated in FIG. 2, a display (an example of “display device”) 12, speakers (each of which is an example of “sound output device”) 13, and a camera 14 are installed at the upper portion of the operating handle 4. The camera 14 is installed such that the camera 14 can capture an image of the scenery that the rider is actually seeing.

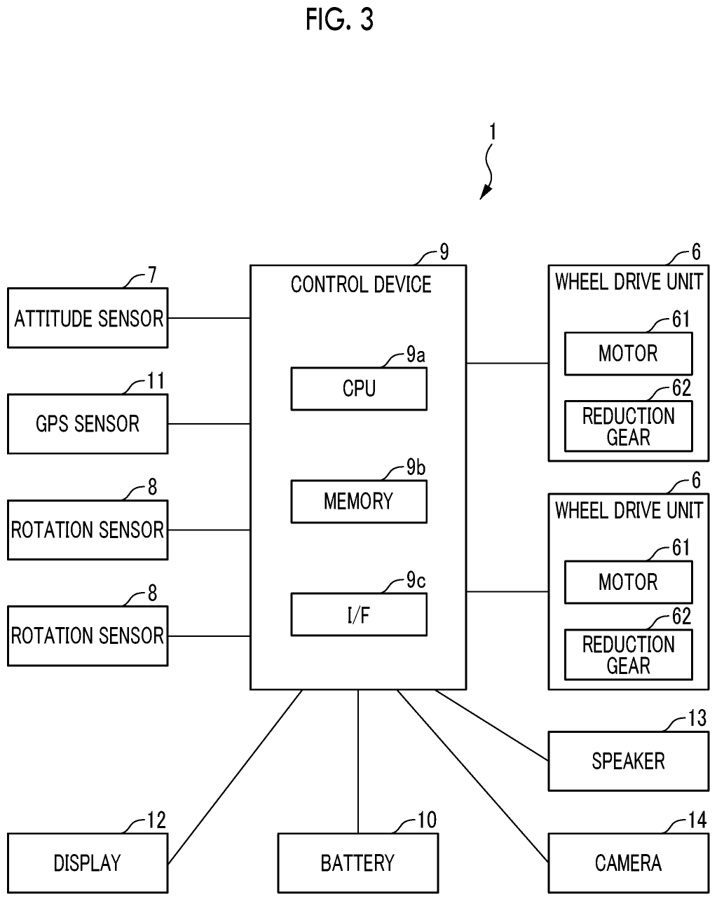

FIG. 3 is a block diagram illustrating the system configuration of the movable body 1. The movable body 1 includes a pair of wheel drive units 6 configured to respectively drive the two drive wheels 5, an attitude sensor 7 configured to detect an attitude of the vehicle body 2, a pair of rotation sensors 8 configured to respectively detect rotation information about the two drive wheels 5, a control device 9 configured to control the wheel drive units 6, a battery 10 from which electric power is supplied to the wheel drive units 6 and the control device 9, a global positioning system (GPS) sensor 11 configured to sense position information, the display 12, the speaker 13, and the camera 14.

The two wheel drive units 6 are built in the vehicle body 2 and configured to respectively drive the right and left drive wheels 5. Each wheel drive unit 6 includes a motor 61 and a reduction gear 62.

The vehicle body 2 is provided with the attitude sensor 7, and the attitude sensor 7 is, for example, a gyro sensor, an acceleration sensor, or the like. When the rider tilts the operating handle 4 forward or backward, the step parts 3 tilt forward or backward. The attitude sensor 7 detects attitude information corresponding to the tilt of the step parts 3, and outputs the detected attitude information to the control device 9.

Each rotation sensor 8 is provided at, for example, a corresponding one of the drive wheels 5, and detects rotation information, such as a rotation angle, rotation angular velocity, or rotation angular acceleration of the corresponding drive wheel 5. Each rotation sensor 8 is, for example, a rotary encoder, a resolver, or the like. Each rotation sensor 8 outputs the detected rotation information to the control device 9.

The battery 10 is built in, for example, the vehicle body 2. The battery 10 is, for example, a lithium-ion battery or the like. The battery 10 supplies electric power to each wheel drive unit 6, the control device 9, other electronic devices, and so forth.

The control device 9 includes a central processing unit (CPU) 9a, a memory 9b, such as a read-only memory (ROM) or a random-access memory (RAM), an input-output interface or communication interface (I/F) 9c, and so forth. The control device 9 may include a storage device, such as a hard disk drive. The control device 9 implements various functions when the CPU executes programs stored in, for example, the ROM. The control device 9 executes predetermined computing processing based on, for example, attitude information output from the attitude sensor 7, and rotation information about the drive wheels 5 output from the rotation sensors 8, and the control device 9 outputs required control signals to the wheel drive units 6. The control device 9 causes the display 12 to display a performance image and causes the speaker 13 to output performance sound, based on the position information about the movable body 1, which is output from the GPS sensor 11, and the attitude information output from the attitude sensor 7.

The GPS sensor 11 measures current position information about the movable body 1. The GPS sensor 11 is, for example, a part of a position information measurement system using artificial satellites. The GPS sensor 11 receives radio waves from a large number of GPS satellites, thereby highly accurately measuring a position (longitude, latitude, and altitude) at any point on the earth.

The display 12 provides image information to the rider, based on signals from the control device 9.

The speaker 13 provides sound information to the rider, based on signals from the control device 9.

The camera 14 captures a video image of the scenery coming into the rider's field of vision, and provides the captured video image to the control device 9. The captured video image can be displayed on the display 12 via the control device 9.

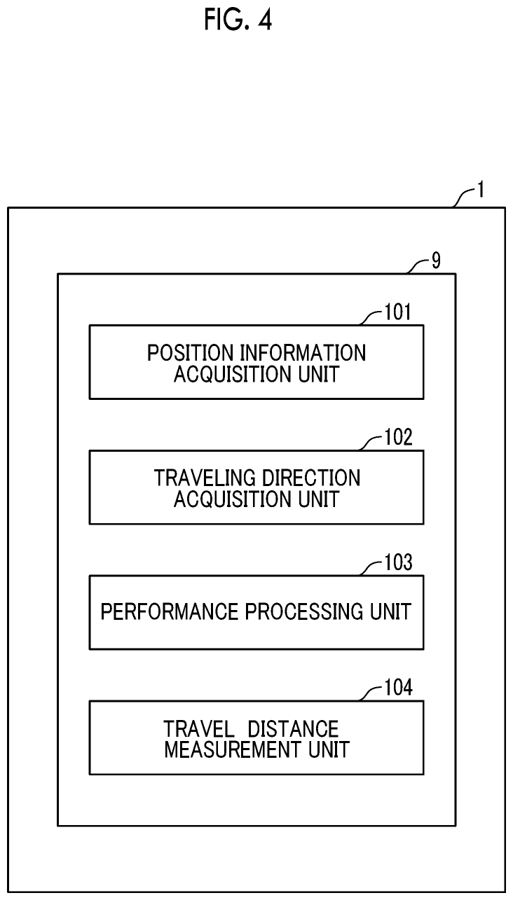

FIG. 4 is a block diagram illustrating functional modules to be implemented by the control device 9 of the movable body 1. The functional modules include a position information acquisition unit 101, a traveling direction acquisition unit 102, a performance processing unit 103, and a travel distance measurement unit 104.

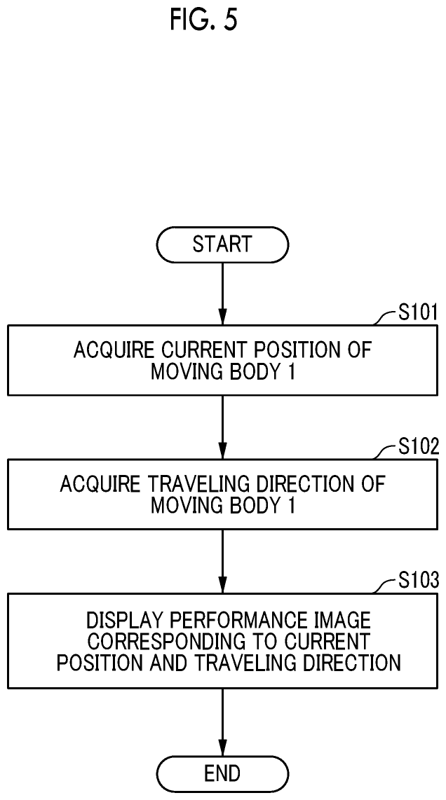

Next, operations of the movable body 1 will be described with reference to the flowchart in FIG. 5. The position information acquisition unit 101 acquires a current position of the movable body 1 measured by the GPS sensor 11 (step S101).

Further, the traveling direction acquisition unit 102 acquires a traveling direction (azimuth) of the movable body 1 detected via the attitude sensor 7 (step S102).

Next, the performance processing unit 103 causes the display 12 to display a performance image corresponding to the current position and traveling direction of the movable body 1 (step S103). The performance image may be stored in a storage device mounted on the movable body 1 or may be acquired, through a communication line, from a server device installed in a management center or the like. The performance processing unit 103 may cause the speaker 13 to output sound (description of a screen, sound effects, or the like) matching the image displayed on the display 12.

Next, an example of the image that is displayed on the display 12 will be described.

Virtual Reality-Based Performance

First, virtual reality-based image performance (image performance provided by using virtual reality (VR)) will be described. The performance processing unit 103 causes the display 12 to display scenery from a current position of the rider, at a time point that differs from the present time. That is, the performance processing unit 103 replaces the scenery coming into the rider's field of vision, which is specified based on the current position and traveling direction of the movable body 1, with an image of the scenery at a location corresponding to the current position of the rider at a time point that differs from the present time. The performance processing unit 103 causes the display 12 to display the image of the scenery at the corresponding location at the time point that differs from the present time. The image that is displayed may be, for example, an image of the scenery at a selected past period (e.g., the Edo period). Specifically, for example, while the movable body 1 is traveling in the vicinity of Nihonbashi, a video image of the old Nihonbashi streetscape is displayed on the display 12, so that the rider can enjoy comparison between the current streetscape and the old streetscape. For example, while the movable body 1 is traveling in the Sekigahara Battlefield Site, a battle scene of Sekigahara may be displayed. In this case, when the rider operates the operating handle 4 to change the traveling direction, the scenery may be changed accordingly (e.g., the eastern army is displayed when the rider operates the movable body 1 to the right, and the western army is displayed when the rider operates the movable body 1 to the left). In this way, the rider has a virtual experience of being in the battlefield.

Other examples include: displaying an image of a completed building while the movable body 1 is traveling in a construction site (e.g., displaying an image of an apartment under construction); displaying, in bad weather, an image of the scenery to be seen in clear weather in a location with a nice view; and displaying an image with cherry blossoms in full bloom, at a famous place for cherry-blossom viewing in a season when cherry blossoms do not bloom. In addition, it is possible to display an image that allows the rider to enjoy comparison between the actual scenery and a virtual scenery.

In the present embodiment, the scenery corresponding to the current position and traveling direction of the movable body 1 is displayed. However, the correspondence between the displayed scenery and the current position and the traveling direction of the movable body 1 need not be significantly strict. Further, an actual movement of the movable body 1 and a change in the view that is displayed need not strictly correspond to each other. For example, while the movable body 1 is within a certain distance from a predetermined point (e.g., Nihonbashi), the streetscape in the vicinity of Nihonbashi in the Edo period may be displayed.

The image for a virtual experience need not be displayed at all times, and may be displayed only when the movable body 1 is traveling in a location set in advance.

Image performance may be provided such that the rider has a virtual experience of traveling inside a building that no longer exists (e.g., a castle that used to exist in the ruins of a castle) or traveling inside a building that the rider cannot enter because it is closed (e.g., a museum or a historical building). Specifically, when the movable body 1 passes a predetermined location, image performance is provided such that the rider has a virtual experience of entering a building from its entrance, and thereafter, image performance is provided such that the rider has a virtual experience of moving around inside the building in accordance with the movement of the movable body 1. In this case, a video image may be changed in accordance with a change in the position information about the movable body 1 measured by the GPS sensor 11. Alternatively, the video image may be changed based on the travel distance and azimuth relative to a specific point (e.g., the entrance of the building). The travel distance and azimuth relative to the specific point can be measured by the travel distance measurement unit 104, based on the rotation information about each drive wheel 5, which is obtained via the corresponding rotation sensor 8, and the orientation of the movable body 1, which is obtained via the attitude sensor 7. According to this method, the relative travel distance can be measured even in a location (e.g., a location in a building) where it is not possible to receive radio waves from the GPS satellites.

Augmented Reality-Based Performance

Next, augmented reality-based performance (image performance provided by using augmented reality (AR)) will be described. The performance processing unit 103 causes the display 12 to display an image of virtual reality such that the image of virtual reality is superimposed on the actual scenery (the scenery that the rider is actually seeing). The performance processing unit 103 causes the display 12 to display an image of the actual scenery captured by the camera 14. Further, the performance processing unit 103 causes the display 12 to display an image, such as computer graphics, such that the image, such as computer graphics, is superimposed on the actual image. The image to be superimposed on an actual image may be stored in the storage device mounted on the movable body 1 or may be acquired, through the communication line, from the server device installed in the management center or the like.

For example, an image of a building that used to exist or an image in which people of the Edo period are walking may be superimposed on the actual scenery. For example, image processing may be executed to create an image in which a helmet is placed on the head of a person who is in the actual scenery. Such image processing can be executed by the control device 9 or a remote server device.

Image processing may be executed to create an image in which an object that is in an image of the actual scenery is replaced with another image, and the processed image may be displayed. Such image processing can be executed by the control device 9 or a remote server device. For example, an automobile (a moving object) in the actual scenery may be replaced with an animal, such as a cow or a horse, or an actual building may be replaced with a building in old times.

Another Example of Movable Body

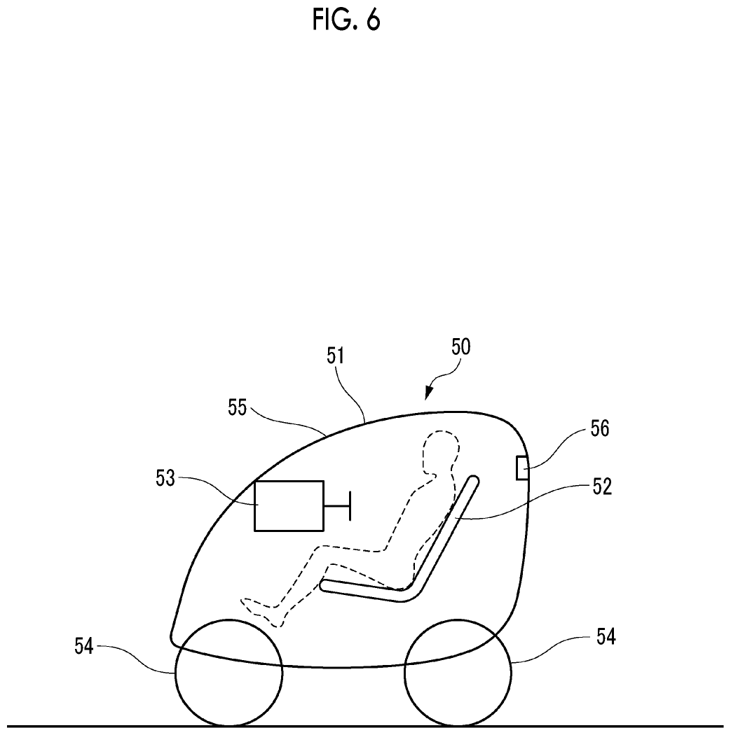

FIG. 6 is a view illustrating the schematic configuration of a movable body 50 according to a second embodiment. The movable body 50 is a one- or two-seater small vehicle. Traveling of the movable body 50 may be controlled through an operation of a rider. Further, the movable body 50 may be allowed to perform autonomous traveling when the traveling mode is switched to an autonomous traveling mode. As illustrated in FIG. 6, the movable body 50 includes a vehicle body 51, a seat unit 52, an operation unit 53, a pair of right and left drive wheels 54, a display 55, and a projector 56. The seat unit 52 is configured such that a rider is seated therein. The operation unit 53 is configured to be gripped by the rider and operated to drive the movable body 50. The drive wheels 54 are rotatably attached to the vehicle body 51. The display 55 is transparent or translucent, and is installed so as to allow the rider to see the scenery ahead of the rider. The projector 56 is installed at a rear portion of the vehicle body 51, and is configured to project an image onto the display 55. The movable body 50 has the same system configuration as that of the movable body 1. In the movable body 50, it is possible to provide performance using image and sound, in the same manner as that in the movable body 1.

For example, in the movable body 50, the performance processing unit 103 executes control such that a building image of computer graphics is displayed on the display 55 that is transparent or translucent. As a result, the rider has a virtual experience of seeing a virtual building in the streetscape ahead of the rider.

According to the foregoing embodiment, in the movable body 1, such as a small vehicle, a performance image corresponding to the current position and traveling direction of the movable body 1 is displayed on the display 12, and therefore, the rider has a virtual experience full of realism while traveling on the movable body 1. For example, when the scenery of a corresponding location in a past period (or in the future) is displayed, the rider can enjoy comparison between the current scenery and the past (or the future) scenery.

A more entertaining image can be provided by superimposing an image, such as computer graphics, on an image of the actual scenery captured by the camera 14.

Further, it is also possible to display an image of a building that does not actually exist or an image of the inside of a building that the rider cannot enter, and therefore, it is possible to provide the rider with various kinds of entertainment. In this case, when the image of the inside of the building is changed based on the travel distance and traveling direction relative to a specific location, it is possible to provide a virtual experience of actually travelling inside the building.

By outputting, from the speaker 13, sound matching an image displayed on the display 12, it is possible to provide image performance with a higher degree of realism.

The disclosure is not limited to the foregoing embodiments and various changes and modifications may be made to the foregoing embodiments within the scope of the appended claims. Thus, the foregoing embodiments that have been described in the specification are to be considered in all respects as illustrative and not restrictive. For example, the foregoing processing steps may be changed in order or executed in parallel, as long as no contradiction occurs in the processing content.

What is claimed is:

1. A movable body configured to travel with a rider on board, the movable body comprising:
a control device configured to acquire a current position of the movable body and acquire a current traveling direction of the movable body; and
a display device installed such that the rider is able to see the display device,
wherein the control device is configured to execute control such that the display device displays a performance image corresponding to the current position and the current traveling direction.

2. The movable body according to claim 1, wherein the control device is configured to execute control such that the display device displays an image of scenery seen from a point of view based on the current position and the current traveling direction, the scenery being scenery at a time point that differs from present time.

3. The movable body according to claim 1, wherein the control device is configured to execute control such that the display device displays an image of virtual reality superimposed on actual scenery.

4. The movable body according to claim 1, wherein:
the control device is further configured to measure a travel distance of the movable body and a traveling direction of the movable body; and
the control device is configured to execute control such that the display device displays an image of an inside of a building that the rider is not able to actually enter, based on the measured travel distance of the movable body and the measured traveling direction of the movable body.

5. The movable body according to claim 4, wherein the control device is configured to execute control such that a video image of the inside of the building is changed based on the measured travel distance of the movable body and the measured traveling direction of the movable body.

6. The movable body according to claim 1, further comprising a sound output device, wherein the control device is configured to execute control such that the sound output device outputs sound matching an image displayed on the display device.

7. The movable body according to claim 1, further comprising a camera configured to capture a video image of scenery coming into the rider's field of vision,
wherein the control device is configured to execute control such that the performance image is superimposed on the video image captured by the camera.
